(19) United States
(12) Patent Application Publication
(10) Pub. No.: US 2008/0084311 A1
(43) Pub. Date: Apr. 10, 2008

(54) Inductance enhancement by magnetic material introduction

(75) Inventor: James Fred Salzman, Anna, TX (US)

Correspondence Address: TEXAS INSTRUMENTS INCORPORATED, P O BOX 655474, M/S 3999, DALLAS, TX, 75265, US

(73) Assignee: Texas Instruments, Dallas, TX (US)

(21) Appl. No.: 11/544,112

(22) Filed: Oct. 6, 2006

(51) Int. Cl. G08B 13/14

(52) U.S. Cl. 340/572.8; 340/572.7; 340/572.6; 340/572.5

(57) ABSTRACT

In a described implementation of inductance enhancement by magnetic material introduction, a substrate that supports an inductive element has magnetic material introduced thereto.

### BACKGROUND

Computers, mobile phones, and other electronic devices are sold in increasingly greater volumes. Electronic devices include many different internal components to facilitate their computational, communicational, and other functions. Reducing the number or size of such components can decrease the overall size of a given electronic device and/or lower its cost.

The cost of electronic devices can also be lowered by reducing the distribution and sales expenses. One mechanism for reducing the distribution and sales expenses of goods is utilization of a radio frequency identification (RFID) tag scheme. RFID tags are relatively small tags that provide identification via a radio frequency (RF) interface. They may be placed on individual goods and/or on shipping containers to speed distribution and ultimately facilitate sales to the final consumer.

### SUMMARY

In a described implementation of inductance enhancement by magnetic material introduction, a substrate that supports an inductive element has magnetic material introduced thereto. Other method, system, apparatus, device, procedure, arrangement, etc. implementations are described herein.

### DESCRIPTION OF THE DRAWINGS

The same numbers are used throughout the drawings to reference like and/or corresponding aspects, features, and components.

FIG. 1 is a block diagram of an example system having a radio frequency identification (RFID) tag and a printed circuit board (PCB), each of which has a substrate, an inductive element, and magnetic material.

FIG. 2 is a functional block diagram of an example RFID tag having an inductive element and magnetic material.

FIG. 3 is a diagram of an example RFID tag formed from a substrate and having a reception antenna inductive element and magnetic material.

FIG. 4 is a functional block diagram of an example PCB having an inductive element and magnetic material.

FIG. 5 is a diagram of an example PCB formed from a substrate and having an inductor component inductive element and magnetic material.

FIG. 6 is a flow diagram that illustrates an example method for making an apparatus having an inductive element and magnetic material.

### DETAILED DESCRIPTION

Printed circuit boards (PCBs) are present in most electronic devices. Radio frequency identification (RFID) tags are being used with rapidly-increasing frequency for inventory, tracking, sales, and other purposes. PCBs and RFID tags may have a number of elements in common. An example element that is typically common to both is an inductive element.

Inductive elements usually provide inductance-type impedance to a circuit. In RFID tags, for example, the receiving antenna that couples power to the other RFID elements is an inductive element. With PCBs, for example, the inductive components are inductive elements. In both cases, the inductive element is created using some amount of metal on a substrate.

In a described implementation, magnetic material is introduced to the substrate. In operation, the magnetic material interacts with the inductive element so as to increase the inherent inductance value of the inductive element. Thus, the inductance per unit area of a metal inductor may be increased with the introduction of the magnetic material to the substrate. Consequently, the inductive element can be made smaller for a given level of inductance, or the level of inductance can be increased with a given size of inductive element.

Any combination of the above two consequences may be selectively implemented to achieve a desired result. As one example, the power coupling capability of a receiving antenna inductive element in an RFID tag may be increased without otherwise changing the RFID tag by introducing the magnetic material. This can enable (i) an RFID tag to operate farther from an activating transmitter, (ii) the activating transmitter to broadcast at a lower power level, and/or (iii) the RFID tag components to consume more power. As another example, inductor components on a PCB may each be made smaller by introducing the magnetic material to the substrate thereof. This inductor component size reduction reduces the PCB real estate occupied by inductors and therefore can enable-PCBs to be manufactured in smaller sizes. Other alternative real-world implementations are possible.

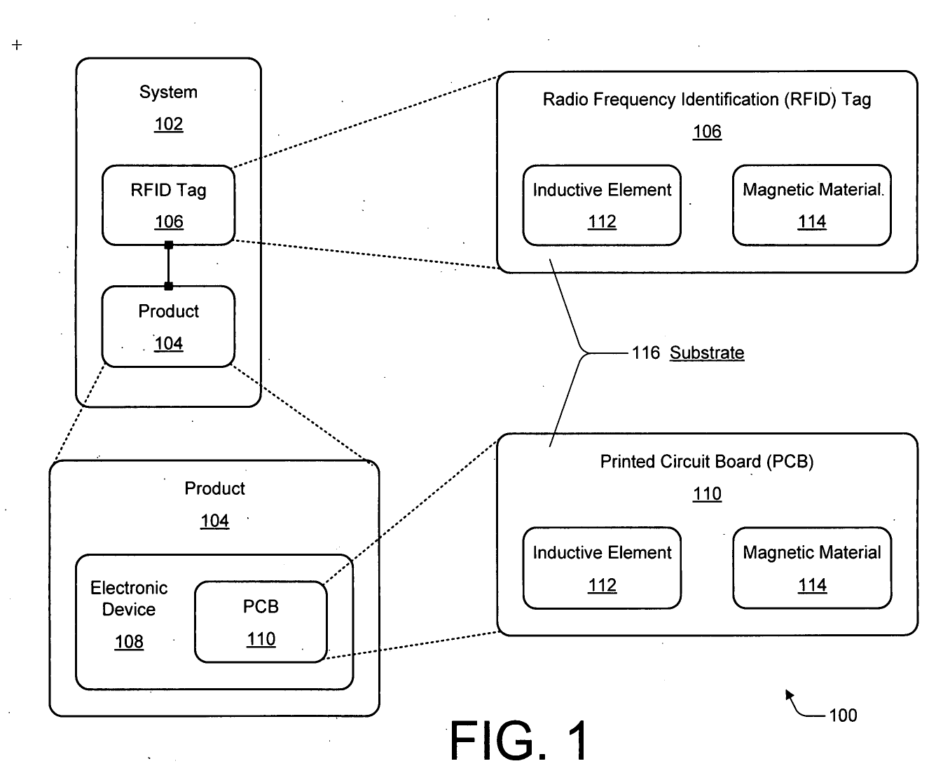

FIG. 1 is a block diagram 100 of an example system 102 having a radio frequency identification (RFID) tag 106 and a printed circuit board (PCB) 110, each of which has a substrate 116, an inductive element 112, and magnetic material 114. As illustrated, system 102 includes a product 104 and RFID tag 106. Product 104 comprises an electronic device 108 that includes a PCB 110. Each of RFID tag 106 and PCB 110 are formed, at least partially, from substrate 116. Each of RFID tag 106 and PCB 110 include an inductive element 112 and magnetic material 114.

In a described implementation, RFID tag 106 is affixed to product 104. Although shown with an electronic device 108, product 104 may more generally be any product whether electronic or not. RFID tag 106 may be affixed to an internal or external portion of the packaging of product 104, or it may be affixed to an internal or external portion of the product itself.

More generally, RFID tags 106 may be co-located with any item or items. Examples include, but are not limited to, individual goods, shipping containers, inventory, financial cards (e.g., credit cards, smart cards, etc.), identification (ID) tags, wallets/purses, other possessions, some combination thereof, and so forth. RFID tags 106 may be affixed in any manner. Examples include, but are not limited to, adhesives, clips, snaps, inherent properties of the packaging or product, ties, some combination thereof, and so forth.

Electronic devices 108 can include one or more PCBs 110. In this context, an electronic device 108 is any device that includes at least one PCB 110. Specific examples of electronic devices 108 include, but are not limited to, computers (e.g., servers, desktops, laptops, hand-held computers, etc.), mobile phones, personal digital assistants (PDAs), computerized vehicles, game machines, home entertainment electronics (televisions, DVD players, DVRs, other video/audio equipment, etc.), some combination thereof, and so forth. It should be noted that electronic devices 108 having PCBs 110 need not be associated with an RFID tag 106.

In a described implementation, each of RFID tag 106 and PCB 110 is formed from a substrate 116. Substrate 1 16 is any insulating or non-conducting material. Each of RFID tag 106 and PCB 110 includes at least one inductive element 112 and magnetic material 114. Non-exhaustive examples of inductive elements 112 are provided herein below. Examples of magnetic material 114 include, by way of example but not limitation, ferrite, certain types of magnetized iron, some combination thereof, and so forth. Magnetic material 114 may be in the form of particles, powder, and so forth. The physical form of magnetic material 1 14 may be modified upon its introduction to substrate 116.

More specifically, a system 102 having an RFID tag 106 and/or a PCB 1 10 may include a substrate 1 16 and an inductive element 112 supported by substrate 116. In other words, inductive element 112 may be disposed on, built in or on, snaked over or through, etc. substrate 1 16. Each inductive element 1 12 has an inductance that is inherent thereto. When magnetic material 114 has been introduced to substrate 116 sufficiently proximate to inductive element 112, the inherent inductance thereof is increased. Example principles indicating the sufficiency of the proximity are described herein below.

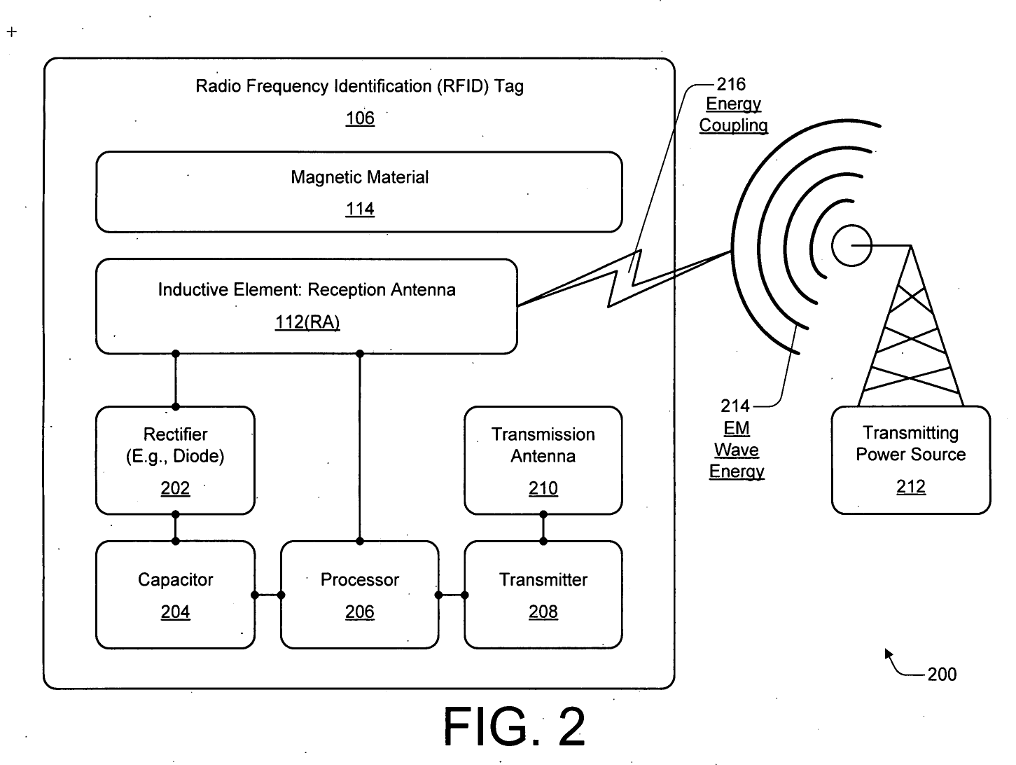

FIG. 2 is a functional block diagram 200 of an example RFID tag 106 having an inductive element 112 and magnetic material 114. For RFID tag 106, inductive element 112 comprises a reception antenna inductive element 112(RA). As illustrated, RFID tag 106 also includes a rectifier 202, a capacitor 204, a processor 206, a transmitter 208, and a transmission antenna 210. Block diagram 200 also includes a transmitting power source or activating transmitter 212.

In a described implementation, reception antenna 112(RA) is coupled directly to rectifier 202 and indirectly to capacitor 204. Capacitor 204 is directly coupled to rectifier 202 and processor 206. Processor 206 is also directly coupled to transmitter 208, which is directly coupled to transmission antenna 210. Processor 206 is at least indirectly coupled to reception antenna 112(RA) to receive incoming signals, and it may be directly coupled to reception antenna 112(RA) as illustrated.

In operation of a described implementation, transmitting power source 212 transmits electromagnetic (EM) wave energy 214 to power (and often to also activate) RFID tag. 106. The energy of EM wave transmission 214 is coupled to RFID tag 106 via reception antenna 112(RA) as indicated by energy coupling symbol 216.

The inductive element, reception antenna 112(RA), couples the energy of EM wave 214 in conjunction with magnetic material 114. More specifically, magnetic material 114 increases the coupling capability or efficiency of reception antenna 112(RA) by increasing its inherent inductance value. The received EM wave energy 214 is provided to rectifier 202. Rectifier 202 may be a diode or other rectification component. Rectifier 202 rectifies the energy to enable collection of the positive or negative portion of EM wave energy 214 by capacitor 204.

Capacitor 204 stores the accumulated charge or energy. The power source for RFID tag 106 is thus reception antenna 112(RA) (as accentuated or intensified by magnetic material 114), rectifier 202, and capacitor 204.

The energy stored by capacitor 204 is made available to processor 206 to perform the function(s) of RFID tag 106. Processor 206 may be capable of performing any general processor functions. However, a processor 206 for an RFID tag 106 is typically a relatively simple processor, such as a state machine. Usually, processor 206 is responsible for providing identifying information. It may also be capable of implementing one or more security-related (e.g., cryptographic) functions.

After receiving an inquiry signal, processor 206 formulates a response. The response is forwarded from processor 206 to transmitter 208. Typically, transmitter 208 is a relatively low-power transmitter due to the power constraints imposed by the limitations of capacitor 204. Transmitter 208 provides the formulated response to transmission antenna 210. Transmission antenna 210 may be any type of antenna. However, for an RFID tag 106, transmission antenna 210 is usually relatively small, such as a patch antenna. In an alternative implementation, RFID tag 106 may have a single antenna in which signal and power reception is effectuated using the same antenna as signal transmission.

Transmission antenna 210 transmits the response over the air. Transmitting power source 212 may also include a receiver and be the intended recipient of the transmitted response. Communication is enabled so long as RFID tag 106 remains sufficiently close to transmitting power source 212 to charge capacitor 204 and to activate processor 206.

In effect, introducing magnetic material 114 to RFID tag 106 enables a number of possible implementation options while keeping other parameters constant. Example possible implementation options include, by way of example but not limitation, the following: First, the size of reception antenna 112(RA) may be decreased. This enables an overall size reduction for RFID tag 106. Second, the amount of power coupled to (e.g., the charge rate of) capacitor 204 by reception antenna 112(RA) may be increased. Third, RFID tag 106 may be capable of activation when located farther from transmitting power source 212.

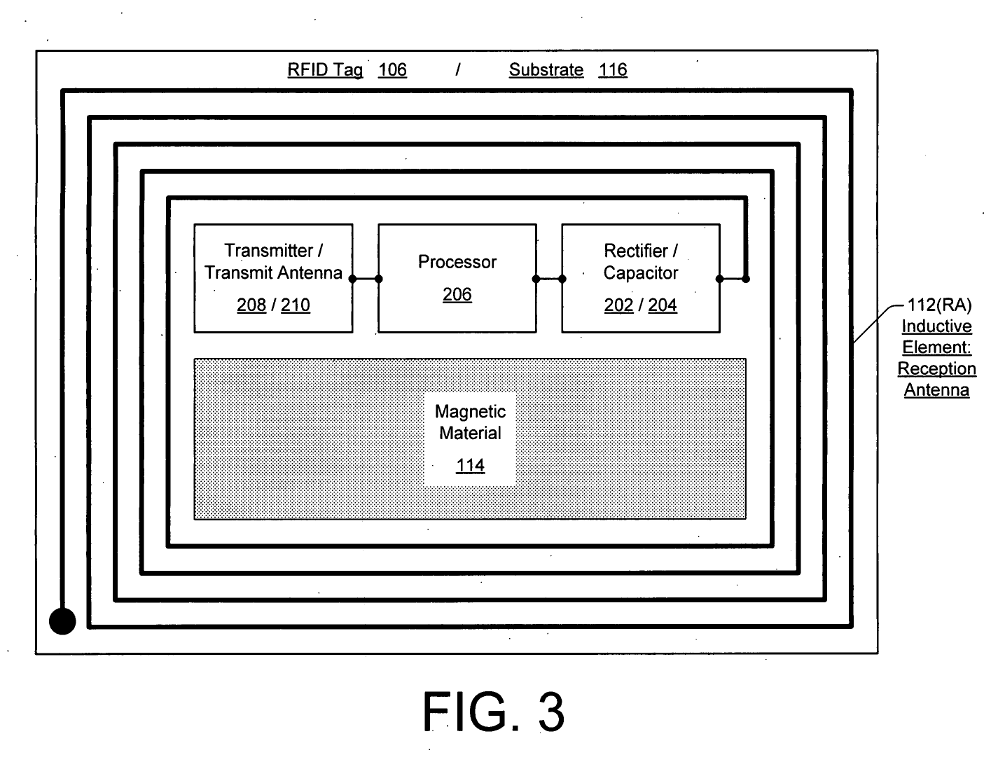

FIG. 3 is a diagram of an example RFID tag 106 formed from a substrate 116 and having a reception antenna inductive element 112(RA) and magnetic material 114. As illustrated, reception antenna 112(RA) is created on substrate 116 by coiling metal until a desired length is reached. Inductance is a function of the area of the metal forming the inductive element. More specifically, the inductive value of an inductive element may be considered a function of the length of the inductive element and the inductance per unit of length. Typically, the metal inductor is snaked around the substrate until the desired length is reached. The snaking may be a back-and-forth pattern, a zig-zag pattern, a coiling pattern (as illustrated), some combination thereof, and so forth.

To form the power source for RFID tag 106, reception antenna 112(RA) is coupled to rectifier/capacitor 202/204. The power source powers processor 206, which is coupled to rectifier/capacitor 202/204. Processor 206 is also coupled to transmitter/transmission antenna 208/210.

Substrate 116 may be any insulating or non-conducting material. In a described RFID tag 106 implementation, example materials for substrate 116 include, by way of example but not limitation, plastic, paper, cloth, cardboard, wood, some combination thereof, and so forth.

Magnetic material 114 may be introduced to substrate 116 in any of many possible manners. Generally, magnetic material 114 may be applied to the surface of substrate 116, magnetic material 114 may be combined with the material of substrate 116, some combination thereof, and so forth.

Magnetic material 114 may be introduced to substrate 116 at any of many possible locations. Generally, magnetic material 114 is located sufficiently proximate to reception antenna 112(RA) so as to increase its inductive coupling capabilities a desired amount. Experiments may provide an exact location and shape for magnetic material 114 for a given geometry of RFID tag 106.

As illustrated, magnetic material 114 is located inside of the coiling of reception antenna 112(RA) but not directly on any of the components 202-210 or on reception antenna 112(RA). This may be accomplished using, for instance, a silkscreening process to apply magnetic material 114 to the surface of substrate 116. However, alternative implementations may entail magnetic material 114 being on (or under), fully or partially, any one or more of the components 202-210 and/or reception antenna 112(RA). For example, magnetic material 114 may be located under up to all of the components 202-210 and reception antenna 112(RA) if magnetic material 114 is combined with the material of substrate 116 during the production of substrate 116.

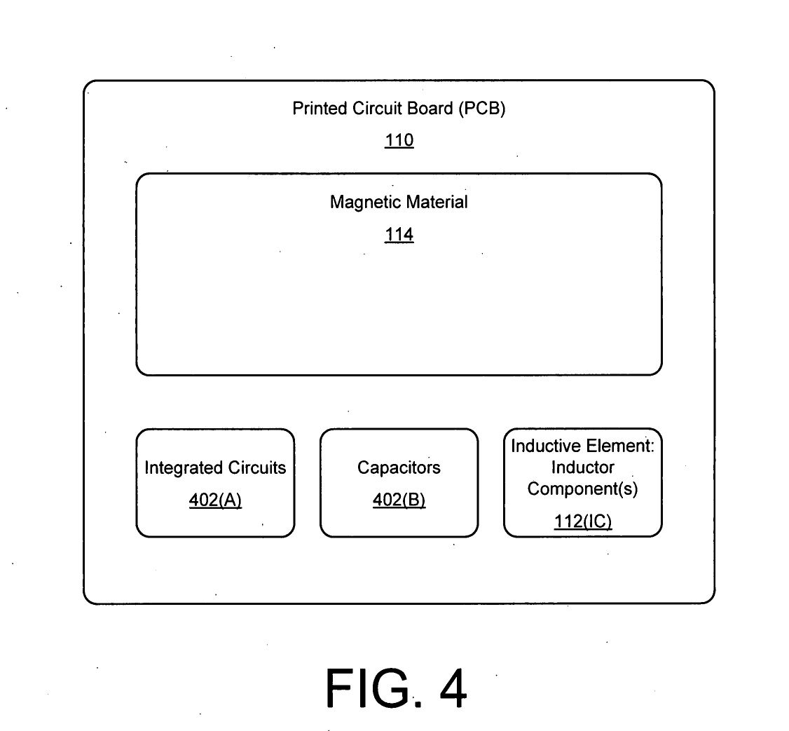

FIG. 4 is a functional block diagram of an example PCB 110 having an inductive element 112 and magnetic material 114. For PCB 110, inductive element 112 comprises at least one inductor component inductive element 112(IC). As illustrated, PCB 110 also includes surface mount devices (SMDs) 402. Although there are other SMD types, the illustrated example types for SMDs 402 are integrated circuits 402(A) and capacitors 402(B).

In a described implementation, inductor component 112(IC) functions as an inductor in a circuit (not separately shown) of PCB 110. The presence of magnetic material 114 increases the inductive efficiency (e.g., with respect to inductance per unit of area) of inductor component 112(IC).

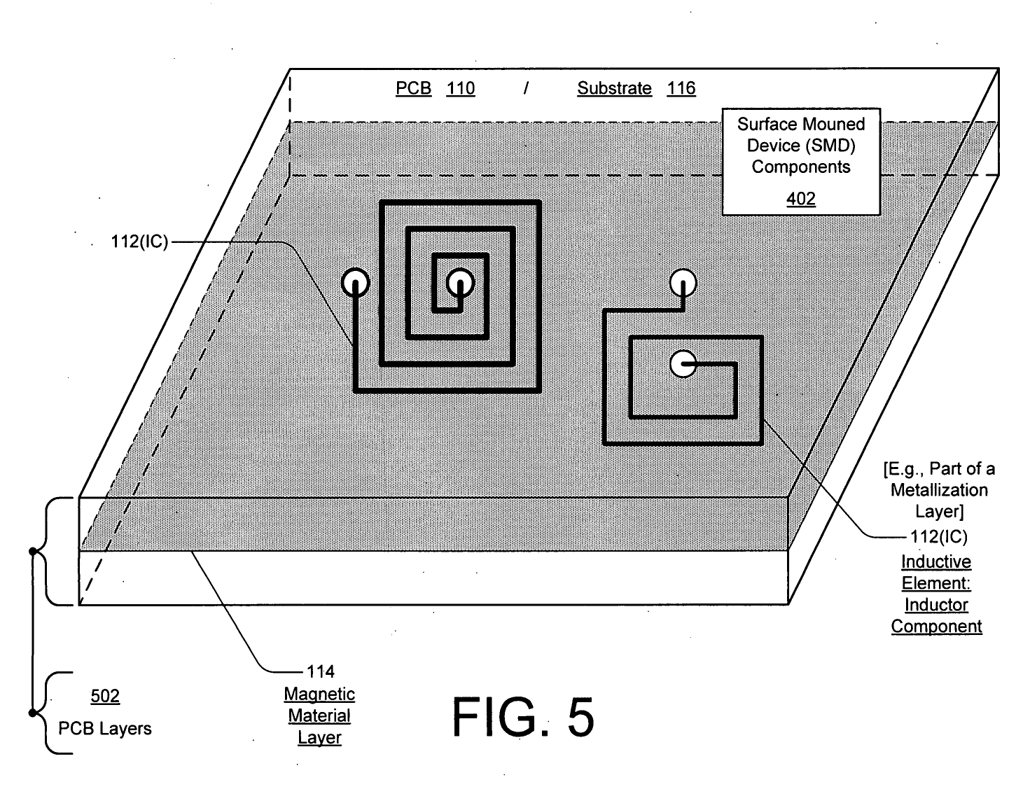

FIG. 5 is a diagram of an example PCB 110 formed from a substrate 116 and having an inductor component inductive element 112(IC) and magnetic material 114. As illustrated, substrate 116 of PCB 110 is formed from multiple PCB layers 502. However, a substrate 116 of a PCB 110 may be formed from a single layer. PCB 110 includes a magnetic material layer 114, one or more SMD components 402, and at least one inductor component 112(IC).

In a described implementation, each inductor component 112(IC) is built in a metallization layer (not explicitly shown) of PCB layers 502. Two inductor components 112(IC) are illustrated, but a PCB 110 may have any number of inductor components 112(IC). Each is realized as a spiral-shaped inductor component 112(IC). However, inductor components 112(IC) may be realized in alternative shapes.

In the example PCB 110 of FIG. 5, magnetic material 114 is introduced to substrate 116 by being combined into substantially an entire layer of PCB layers 502. By way of example only, magnetic material 114 may be mixed into an epoxy fiberglass mixture that is used to produce substrate 116 of PCB 110. However, magnetic material 114 may alternatively be applied to the surface of substrate 116. Moreover, although illustrated as an entire magnetic material layer 114, only a portion of a particular PCB layer 502 may have magnetic material 114 introduced thereto. Likewise, magnetic material 114 may be applied to all or only a portion of the surface of PCB 110. SMD components 402 may be silkscreened out of a surface application of magnetic material 114, or SMD components 402 may be covered by magnetic material 114.

Because magnetic material layer 114 forms at least one layer of PCB layers 502, magnetic material 114 may be sufficiently close to any inductor component 112(IC) that is built using a metallization layer of PCB 110. More specifically, magnetic material 114 may be sufficiently close to a given inductor component 112(IC) so as to increase the inductance per unit area of the given inductor component 112(IC).

The area (e.g., as predominantly represented by the length) of a given inductor component 112(IC) depends on the amount of metal used to form the given inductor component 112(IC) in a metallization layer. As alluded to above, stronger inductors of a given size or smaller inductors of a given strength (or some combination thereof) may be implemented on a PCB 110 when magnetic material 114 is introduced to a substrate 116 thereof. Moreover, magnetic material layer 114 may comprise a core of a transformer, which includes any two relatively proximate inductors 112(IC) and magnetic material 114.

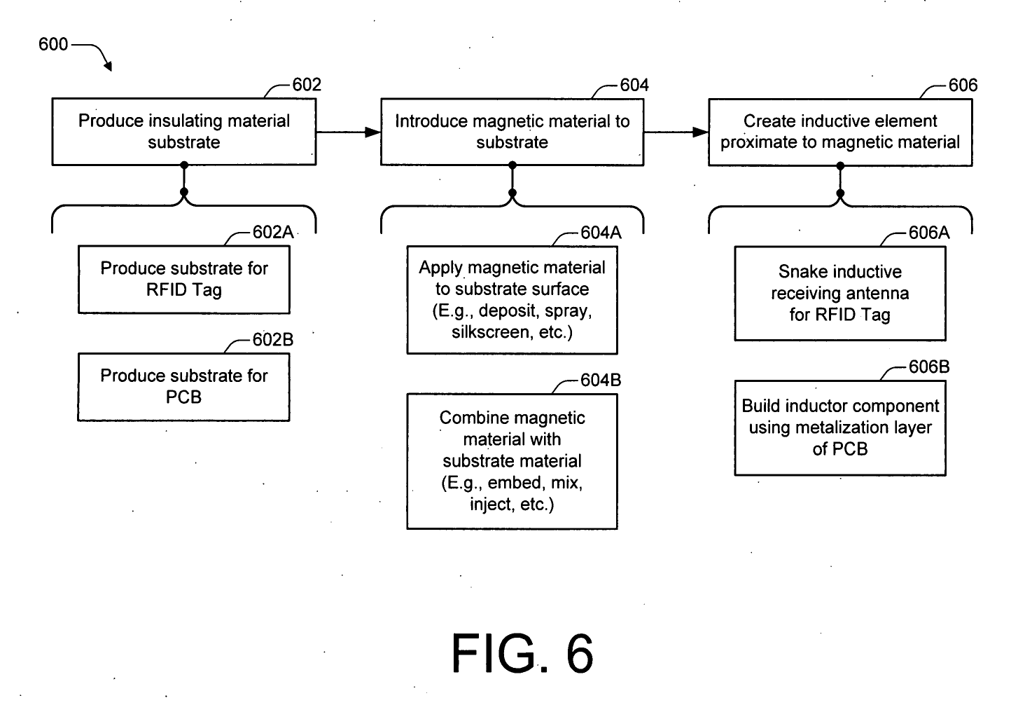

FIG. 6 is a flow diagram 600 that illustrates an example method for making an apparatus having an inductive element and magnetic material. Flow diagram 600 includes three (3) “primary” blocks 602, 604, and 606 and eight (8) “secondary” blocks 602A, 602B, 604A, 604B, 606A, and 606B. Although performance of the actions of flow diagram 600 may result in the manufacture of apparatuses that differ from those described herein above, those apparatuses that are illustrated in FIGS. 1-5 are used below to describe example implementations of the method.

At block 602, an insulating material is produced as a substrate. In one example, a substrate 116 for an RFID tag 106 may be produced (block 602A). In another example, a substrate 116 for a PCB 110 may be produced (block 602B).

At block 604, a magnetic material is introduced to the substrate. In one example, magnetic material 114 may be applied to a surface of substrate 116 (block 604A). For instance, magnetic material 114 may be deposited, sprayed, silk-screened, etc. onto a surface of a substrate 116. In another example, magnetic material 114 may be combined with a material forming substrate 116 (block 604B). For instance, magnetic material 114 may be embedded, mixed, injected, etc. into a material forming substrate 116. Regardless of whether a particular implementation is for an RFID tag 106 or a PCB 110, magnetic material 114 may be applied to the surface or combined with the material of substrate 116.

At block 606, an inductive element is created proximate to the magnetic material. The inductive element may be disposed on the substrate, snaked on top of the substrate, built on (including “in”) the substrate, or otherwise supported by the substrate when creating the inductive element proximate to the magnetic material. In one example, an inductive reception antenna 112(RA) for an RFID tag 106 may be snaked proximate to magnetic material 114 (block 606A). In another example, an inductor component 112(IC) may be built proximate to magnetic material 114 using a metallization layer of PCB layers 502 of a PCB 110 (block 606B).

The actions illustrated of flow diagram 600 may be performed sequentially. On the other hand, the actions of the “primary” blocks 602-606, as well as those of the “secondary” blocks, may be performed partly, substantially, or completely simultaneously and/or such that they are fully or partially overlapping. As one example, the insulating material of the substrate may be produced (at block 602) substantially simultaneously with the introduction of magnetic material to the substrate (at block 604). For instance, magnetic material 114 may be combined with epoxy and fiberglass when forming substrate 116 (e.g., of a PCB 110). As another example, the inductive element may be created on a substrate first (at block 606), and then the magnetic material may be introduced to the substrate proximate to the inductive element second (at block 604). For instance, an inductive element 112 may be created on a substrate 116 (e.g., of an RFID tag 106) first, and then magnetic material 114 may be silk-screened onto substrate 116 at a location that is proximate to inductive element 112 second.

The devices, actions, aspects, features, functions, procedures, approaches, architectures, components, etc. of FIGS. 1-6 are illustrated in diagrams that are divided into multiple blocks or other elements. However, the order, interconnections, interrelationships, layout, etc. in which FIGS. 1-6 are described and/or shown are not intended to be construed as a limitation, and any number of the blocks or other elements can be modified, combined, rearranged, augmented, omitted, etc. in any manner to implement one or more methods, apparatuses, systems, devices, procedures, RFID tags, PCBs, arrangements, etc. for inductance enhancement by magnetic material introduction.

Moreover, although systems, apparatuses, devices, methods, procedures, techniques, approaches, arrangements, and other implementations have been described in language specific to structural, logical, methodological, and functional features and/or diagrams, it is to be understood that the invention defined in the appended claims is not necessarily limited to the specific features or acts described above. Rather, the specific features and acts described above are disclosed as example forms of implementing the claims.

What is claimed is:

1. An apparatus comprising:
a substrate;
an inductive element supported by the substrate, the inductive element having an inductance that is inherent; and
magnetic material introduced to the substrate;
wherein the magnetic material is sufficiently proximate to the inductive element so as to increase the inductance.

2. The apparatus as recited in claim 1, wherein the substrate, the inductive element, and the magnetic material comprise at least part of a radio frequency identification (RFID) tag.

3. The apparatus as recited in claim 2, wherein the inductive element comprises a reception antenna for the RFID tag, the reception antenna capable of coupling electromagnetic (EM) wave energy to the RFID tag.

4. The apparatus as recited in claim 1, wherein the substrate, the inductive element, and the magnetic material comprise at least part of a printed circuit board (PCB).

5. The apparatus as recited in claim 4, wherein the apparatus comprises an electronic device that includes the PCB.

6. The apparatus as recited in claim 4, wherein the inductive element comprises one or more inductor components that are built using at least one metallization layer of the PCB.

7. The apparatus as recited in claim 6, wherein the magnetic material increases an inductance value per unit of area of the one or more inductor components.

8. The apparatus as recited in claim 4, wherein the substrate comprises fiberglass and epoxy; and wherein the magnetic material is mixed with the fiberglass and the epoxy.

9. A radio frequency identification (RFID) tag comprising:
a reception antenna;
a capacitor coupled to the reception antenna; and
magnetic material;
wherein the reception antenna is capable of coupling electromagnetic (EM) wave energy to the capacitor.

10. The RFID tag as recited in claim 9, wherein the magnetic material increases the EM wave energy coupling capability of the reception antenna.

11. The RFID tag as recited in claim 9, wherein the magnetic material comprises ferrite.

12. The RFID tag as recited in claim 9, further comprising:
a rectifier;
wherein the capacitor is coupled to the reception antenna via the rectifier.

13. The RFID tag as recited in claim 9, further comprising:
a processor;
a transmitter coupled to the processor; and
a transmission antenna coupled to the transmitter;
wherein the processor is powered by the capacitor; and
wherein the processor is capable of communicating with an external entity using the reception antenna, the transmitter, and the transmission antenna.

14. The RFID tag as recited in claim 9, further comprising:
a substrate;
wherein the reception antenna is snaked on the substrate, the capacitor is disposed on the substrate, and the magnetic material is introduced to the substrate.

15. The RFID tag as recited in claim 14, wherein the substrate comprises at least one of plastic, paper, cloth, cardboard, or wood.

16. A method comprising:
producing an insulating material substrate;
introducing a magnetic material to the insulating material substrate; and
creating an inductive element that is proximate to the magnetic material and that is supported by the insulating material substrate.

17. The method as recited in claim 16, wherein the creating comprises snaking an inductive receiving antenna for a radio frequency identification (RFID) tag.

18. The method as recited in claim 16, wherein the creating comprises building an inductor component using a metallization layer of a printed circuit board (PCB).

19. The method as recited in claim 16, wherein the introducing comprises applying the magnetic material to a surface of the insulating material substrate.

20. The method as recited in claim 16, wherein the introducing comprises combining the magnetic material with the insulating material substrate.
